(19) United States
(12) Patent Application Publication
(10) Pub. No.: US 2008/0019640 A1
(43) Pub. Date: Jan. 24, 2008

(54) Dynamically tunable waveguide chip for optical transforms

(76) Inventor: Robert Blum, Palo Alto, CA (US)

Correspondence Address: GEMFIRE c/o HAYNES BEFFEL & WOLFELD LLP, P.O. BOX 366, HALF MOON BAY, CA, 94019, US

(21) Appl. No.: 11/713,988

(22) Filed: Mar. 5, 2007

Related U.S. Application Data
(60) Provisional application No. 60/779,222, filed on Mar. 3, 2006.

(51) Int. Cl. G02B 6/34

(52) U.S. Cl. 385/37

(57) ABSTRACT

A tunable optical waveguide chip for optical transforms. Roughly described, the chip includes a planar waveguide having a lens region and a plurality of individually addressable energy applicators distributed transversely across an optical path through the lens region. By individually controlling the energy applied to each of the energy applicators, a desired index of refraction profile can be induced in the lens region transversely across the optical path for performing any of a variety of optical transforms. The device may include an upstream AWG which focus a wavelength de-multiplexed signal on a focal plane within the lens region. The applicators may be thermo-optic or electro-optic, for example.

### PRIORITY INFORMATION

This application claims the benefit of U.S. Provisional Patent Application No. 60/779,222 entitled “Dynamically Tunable Waveguide Chip for Optical Transforms” filed on Mar. 3, 2006. That application is incorporated by reference for all purposes.

### BACKGROUND

This invention relates generally to the field of optical communications.

In long-distance transmission of optical signals, the accumulation of chromatic dispersion in optical fiber presents serious problems. These problems intensify with an increase in bit rate and the distance traveled by the optical signals. Efforts to date that compensate for dispersion have mainly involved the use of dispersion compensating fiber (DCF).

Dispersion compensating efforts that employ DCF—while well-proven—are not particularly amenable to integration in existing network elements. This is due—in part—because DCF is employed as a large spool of fiber which occupies significant space in a network office and is not adjustable. In addition, service providers that utilize DCF in their networks must accurately characterize the DCF, deploy more expensive optical amplifiers, and accept additional latency added to links employing the DCF [˜20% additional latency for a fully compensated standard-single-mode fiber (SSMF) link]. Finally, DCF cannot satisfy all of the dispersion compensation requirements of many 40-Gb/s links, consequently, a tunable optical dispersion compensator (TODC) having a small tuning range is often required in addition to the DCF.

A TODC employing an arrayed waveguide grating (AWG) and thermo-optic lens is described in U.S. Pat. No. 7,006,730 directed to a “Multichannel Integrated Tunable Thermo-Optic Lens and Dispersion Compensator”). And while the TODC described therein appeared to be an attractive alternative/supplement to DCF, it unfortunately required significant electrical power (7.3 W to tune over 400 ps/nm) and generated relatively high local temperatures thereby negatively impacting its long-term reliability.

Described herein is a tunable optical dispersion compensation apparatus (TODC) which permits the programmable fine tuning of the amount of dispersion compensation applied. The apparatus comprises a silica arrayed-waveguide grating (AWG) directly coupled to a polymer thermo-optic lens. As a result of its inventive construction, the TODC exhibits low loss, large tuning range, low electrical consumption and is readily manufactured using standard processes.

In an aspect of the invention, the TODC is fully solid-state, compact, scales to a large figure-of-merit and may be employed in a variety of optical transmission systems while minimizing the need for DCF.

### SUMMARY

Roughly described, an aspect of the invention is a tunable optical waveguide chip for optical transforms. The chip includes a planar waveguide having a lens region and a plurality of individually addressable energy applicators distributed transversely across an optical path through the lens region. By individually controlling the energy applied to each of the energy applicators, a desired index of refraction profile can be induced in the lens region transversely across the optical path for performing any of a variety of optical transforms. The device may include an upstream AWG which focus a wavelength de-multiplexed signal on a focal plane within the lens region. The applicators may be thermo-optic or electro-optic, for example.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a schematic of a dispersion compensation apparatus constructed according to an aspect of the present invention; and

FIG. 2 shows a schematic of an alternative embodiment of the dispersion compensation apparatus of FIG. 1;

FIGS. 3a and 3b show schematically of the embodiment of the dispersion compensation apparatus of FIG. 1 with additional details;

FIG. 4 shows a series of graphs shown measured transmissivity and group delay of the exemplary tunable optical dispersion compensator for seven different thermo-optic lens settings at three locations in the C-band wherein resolution bandwidth is 10 pm;

FIG. 5 is a schematic of an experimental setup used to evaluate the apparatus of FIG. 1;

FIG. 6 is a graph showing bit error rate vs. signal-to-noise ratio of the experimental setup used to evaluate the apparatus of FIG. 5;

FIG. 7 shows a schematic of another alternative embodiment of a dispersion compensation apparatus according to the present invention;

FIG. 8(a) shows a schematic of an “unfolded” variation of a dispersion compensation apparatus according to an aspect of the present invention;

FIG. 8(b) shows a schematic of an alternative embodiment of the “unfolded” dispersion compensation apparatus of FIG. 8(a); and

FIG. 8(b) shows a schematic of yet another alternative embodiment of the “unfolded” dispersion compensation apparatus of FIG. 8(a).

FIG. 9 is a cross-sectional view depicting a typical heater element, formed on a waveguide.

FIG. 10 shows plots of chromatic dispersion compensation achievable with a number of different parabolic index profiles each superimposed on an intrinsic compensation mechanism.

FIG. 11 shows a 2-d cross-sectional plot of temperature levels in an embodiment of the claimed invention in which a single element is heated.

FIG. 12 plots core temperature as a function of transverse distance for an optimized set of heater powers, over half of the parabola.

FIG. 13 shows a 2-d cross-sectional plot of temperature levels in an embodiment of the claimed invention in which two elements is heated.

FIG. 14 is a plot of temperature distribution in the embodiment of FIG. 13.

FIGS. 15-17 show what happens if a heater array of only two heating elements is used.

FIG. 18 depicts the temperature profile formed when a triangular electrode is employed.

### DETAILED DESCRIPTION

Optical switching, multiplexing, and demultiplexing have been accomplished in the past by using an interconnection apparatus having one or more input waveguides communicating with the input of a star coupler. The output of the star coupler communicates with an optical grating comprising a series of optical waveguides, each of the waveguides differing in length with respect to its nearest neighbor by a predetermined fixed amount. The grating is connected to the input of a second star coupler. The second star coupler has one or more output waveguides which form the outputs of the switching, multiplexing, and demultiplexing apparatus. An example of such an interconnection apparatus is disclosed in U.S. Pat. Nos. 5,002,350 and 5,136,671, the entire contents and teachings of which are incorporated herein by reference.

The geometry of such an apparatus may be such that a plurality of separate and distinct wavelengths each launched into a separate and distinct input port of the apparatus will all combine and appear on a predetermined one of the output ports. In this manner, the apparatus performs a multiplexing function. The same apparatus may also perform a demultiplexing function. In this situation, a plurality of input wavelengths is directed to a predetermined one of the input ports of the apparatus. Each of the input wavelengths is separated from the others and directed to a predetermined one of the output ports of the apparatus. An appropriate selection of input wavelength also permits switching between any selected input port to any selected output port. Accordingly, these devices are referred to as frequency routing devices.

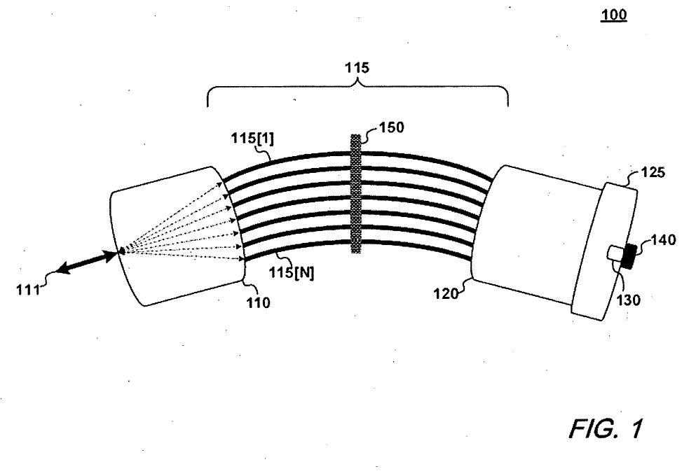

Sharing some common elements with such frequency routing devices, FIG. 1 shows in schematic form the pertinent details of the tunable dispersion compensation apparatus. The apparatus includes an input/output waveguide port 111 connected to an input circle of a free space region of a slab waveguide 110 (first star coupler).

A plurality of output ports extends from an output circle of the free space region of the slab waveguide 110 and is connected to an optical grating 115. The optical grating 115 comprises a plurality of unequal length waveguides 115[1] . . . 115[N] which provides a predetermined amount of path length difference to a corresponding plurality of input waveguides connected to an input circle of a free space region of another slab waveguide 120 (second star coupler). A half-wave plate 150, is disposed at substantially a mid-point of the grating 115

At an opposite, output end of the slab waveguide 120, positioned adjacent (where output waveguides would be located in a “pure” frequency routing device), is a planar lightwave circuit (PLC) 125 which includes a heating element(s) 130 and a mirror 140. For present purposes, the PLC is constructed from a material that exhibits a suitable refractive index change upon heating while, at the same time, exhibiting a sufficient thermal conductivity such that it is easily heated. Overall, what is used is a PLC having adequate thermal properties to exhibit a good thermal profile and thus, a preferably parabolic or similar index profile on the required length scale (˜550 um in this case). In this manner, the PLC behaves as a thermo-optic lens by providing a preferred parabolic (or similar) refractive index profile whose magnitude can be electrically (heated) controlled. As used herein, a purely parabolic profile is considered symmetric about a center frequency, with the index change at one frequency extreme equaling the index change at the opposite frequency extreme; and the “magnitude of the profile” is the magnitude of the index change at either frequency extreme.

When configured in this manner, portions of light input to input/output waveguide 111 traverses the first slab waveguide 110, the grating 115, the second slab waveguide 120, traverses the thermo-optic lens PLC 125, is reflected by the mirror 140, and subsequently output via input/output waveguide 111 having a majority of its accumulated dispersion compensated.

In a preferred embodiment, the mirror 140 length along slab 120 will only be equal to or less than the width of the Brillouin zone. This ensures that high diffraction orders from the grating are not reflected back into the grating. In addition, the mirror 140 is substantially flat as it is easiest to cut and/or polish a flat surface, both for the PLC 125 and for the mirror 140. As can be appreciated, when the mirror 140 is flat, the device provides negative dispersion when no heating elements in 130 are activated which compensates the dispersion of most single-mode optical fibers, most notable standard single-mode fiber, which has a dispersion of ˜+17 ps/nm/km in the C-band. In another embodiment, a curved mirror is employed, to alter the intrinsic compensation of the device, the curve being adapted as know to those of skill in the art.

It may be noted at this point that one may advantageously use the heating elements to adjust focal length and/or add a constant phase since the heat profile includes an offset that may be adjusted as needed. Alternatively, certain ones of the heating elements may be used to generate an offset while others may be used to create the parabolic (or similar) heat profile. As can be readily appreciated by those skilled in the art, through the selective use of heating elements nearly any suitable heat and/or index distribution may be produced, whether or not parabolic, as needed and/or desired.

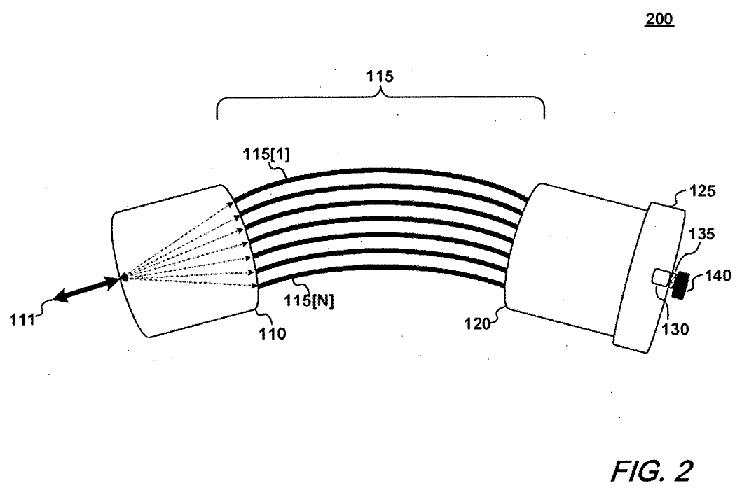

Referring now to FIG. 2, there is shown an alternative embodiment of the tunable dispersion compensator. Shown in FIG. 2 is a configuration in which a quarter-wave plate 135 is positioned between the PLC 125 and the mirror 140. This will cause transverse electric polarization to flip to transverse magnetic polarization and vice-versa upon reflection from the mirror and quarter-wave plate, advantageously reducing the polarization dependency of the dispersion compensator.

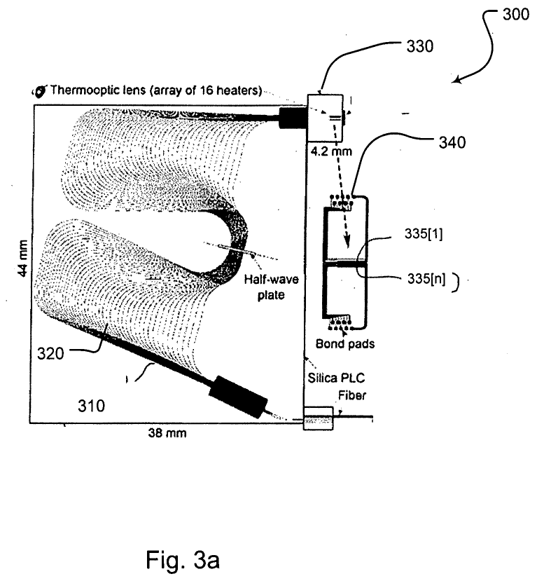

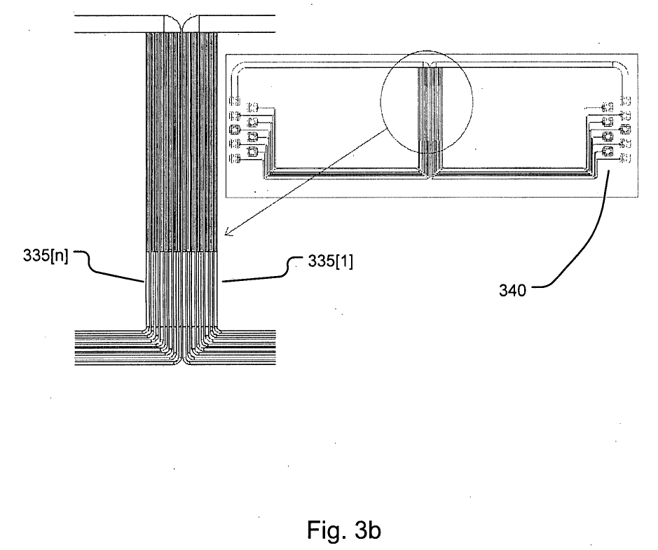

FIG. 3a shows a schematic of an exemplary tunable optical dispersion compensator (TODC) 300 constructed according to the inventive principles. More particularly, the TODC comprises a silica PLC (˜38×44 mm²) 310 having an AWG 320 attached to a much smaller (˜4.2×10 mm²) polymer PLC 330 comprising a thermo-optic lens 340. In this exemplary embodiment, the silica waveguides are substantially 6.0 μm high and exhibit an index contrast of 0.80%, disposed on a silicon substrate.

As constructed, the AWG 320 has 44 gratings arms, a free-spectral range of Δf=100 GHz, a grating inlet pitch of a=15 μm, and a star coupler radius of R=7.76 mm (in silica). Thus the width of the central Brillouin zone is 550 μm in the C-band. The gratings arms are brought close together in the grating center, where a thin half-wave plate may be inserted to achieve polarization insensitivity, as shown and described previously.

Advantageously, the polymer PLC 330 is a simple slab waveguide on a glass substrate so no core patterning is necessary. The core is 7.5-μm thick and has an index contrast of 0.45%. Both core and cladding are polysiloxane-based materials whose optical properties and overall reliability have been well characterized. (See, e.g., A. W. Norris, J. V. DeGroot, T. Ogawa, T. Watanabe, T. C. Kowalczyk, A. Baugher, and R. Blum, “High reliability of silicone materials for use as polymer waveguides” Proc. SPIE Vol. 5212, p. 76-82, November 2003; and T. C. Kowalczyk and R. Blum, “Polymer variable optical attenuator arrays: pathway from material platform to qualified telecom product”, Proc. SPIE Vol. 5517, p. 50-61, October 2004), both incorporated by reference herein.

As noted before, polymer PLC 330 acts as a thermal lens by exhibiting a parabolic (or similar) refractive index profile whose magnitude and shape can be electrically controlled. Other possible heater designs are possible, but a very suitable approach, which is also robust to process variations, is to use a linear array of individually addressable heaters 335[1] . . . 335[16], as shown most clearly n the f FIG. 3b. Thermal simulations showed that despite the discrete nature of the design, a plot of core temperature vs. spatial location along the mirror should be almost perfectly parabolic (standard deviation value of R²>99.8%) when 16 individual heater elements are used and as shown in FIG. 3b.

The 16 heaters (2-mm length, 40-μm spacing) 335[1] . . . 335[16] are patterned on a top surface of the polymeric polysiloxane slab using standard photolithography and connect to traces that fan out to bond pads at the two edges of the polymer PLC. Advantageously, the heaters can be individually addressed and driven with an appropriate power distribution so as to create a parabolic heat distribution, which can be either positive or negative. Because the magnitude of the index change with temperature is ˜35 times higher in this polymer than in silica, and the thermal conductivity of the polymer is ˜8 times lower than in silica, the polymer thermo-optic lens consumes ˜1% of the power of a corresponding silica thermo-optic lens. In addition to the much lower power consumption, the approach described herein enables a significantly larger tuning range since there are fundamental limitations on how much power can be applied to the heater electrodes and the corresponding temperature rise. While this exemplary embodiment advantageously uses polysiloxane, other materials, polymeric or other, may be used. Such other materials should preferably exhibit an index change of at least 2× that of silica and exhibit a thermal conductivity that is less than that of silica. In one particular embodiment, a thermal conductivity that is less than 0.5× that is silica is sufficient.

At an end of the 4.2 mm PLC opposite to the AWG, is positioned a small flat mirror 345 that is substantially 550 μm wide. The mirror 345 may be affixed to the PLC with any of a variety of known adhesives and the width of the mirror 345 is substantially equal to or less than the Brillouin zone width which—as noted earlier—ensures that high diffraction orders from the grating are not reflected back into the grating.

The dispersion exhibited when the lens is unpowered (unheated) is given by

$${D}_{0} = - \frac{2 Rf}{{n ( aΔ f )}^{2}} \qquad [ 1 ]$$

where f is the optical frequency, n is the refractive index, and Δf is the grating free-spectral range. In the embodiment shown, Δf=100 GHz, the index n (for silica and polymer) is in the range 1.4 to 1.6, and the array pitch is 15 μm. This evaluates to −924 ps/nm in the present case at f=194 THz. By way of comparison, an AWG having a flat mirror at one end of one of the star couplers gives negative dispersion, which is what is needed for compensating the dispersion of single mode fiber (SSMF).

As can be readily appreciated, one can use the thermo-optic lens to tune the dispersion about this negative bias point. Because the path-length differences in the AWG of the exemplary compensator 300 are so large (˜87-mm path-length difference between the shortest and longest arms), significant phase errors are introduced in the fabrication that varied from device to device. Fortunately, such errors may be compensated to first order by adjusting the AWG focal length. In the exemplary device(s), this is accomplished by cutting the AWG chip in the star coupler to the proper length before attaching the polymer chip.

Before inserting the half-wave plate, the AWG polarization-dependent wavelength shift of the exemplary device is 17 pm. When no power is applied to the thermo-optic lens (heater), the dispersion is −918 ps/nm, very close to that predicted by Eq.(1).

Using thermal modeling results, an initial estimate of the 16 drive powers of the thermo-optic lens to achieve 0 ps/nm dispersion is generated. The 16 values are then manually adjusted to achieve as close to 0 ps/nm across as wide a bandwidth as possible. Advantageously, the heaters respond quickly and consistently. Accordingly, the resulting set of 16 drive powers is then multiplied by a single variable in order to tune the dispersion to any other desired value (e.g., when the variable is 0 the dispersion is −918 ps/nm, and when the variable is 1.00 the dispersion is 0 ps/nm). Thus the calibration and control are simple. For the measurements presented here, the variable ranges from −0.33 to 1.67.

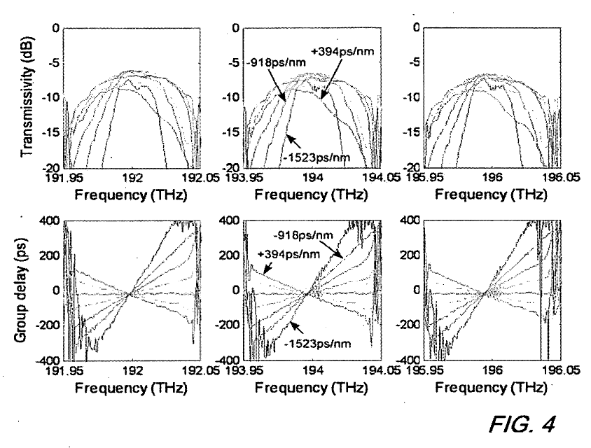

The measured transmissivity and group delay are shown in FIG. 4 at three locations in the C-band for seven different thermo-optic lens settings. The average dispersion values for the seven cases are −1523, −918, −565, −269, −14, +207, and +394 ps/nm. The limit is set by requiring a reasonable transmissivity passband. The 3-dB transmissivity bandwidths are 29, 39, 54, 66, 76, 65, and 58 GHz, respectively. The lens total power consumptions are 29, 0, 15, 30, 44, 59, and 74 mW, respectively. Measuring with a 10-pm resolution bandwidth, the peak-to-peak group delay ripple (GDR) ±25 GHz from the ITU grid is typically <20 ps, but can be as high as 50 ps in the −1523-ps/nm case. The polarization-dependent loss (PDL) is typically <0.6 dB, but can be as high as 1.2 dB in the −1523-ps/nm case. The differential group delay (DGD) is typically <10 ps, but can be as high as 20 ps in the −1523-ps/nm case. There is a small reflection from the half-wave plate.

As can be observed, the group delay bandwidth is nearly as wide as the FSR (100 GHz). Thus the exemplary TODC is especially suitable for compensating 40-Gb/s transmitters or non-wavelength locked 10-Gb/s transmitters on a 100-GHz grid.

Additionally, the insertion loss (not including a circulator) at the passband peak is ˜7 dB. Approximately 0.7 dB is due to round-trip fiber coupling loss, ˜0.8 dB is due to round-trip waveplate insertion loss, ˜0.6 dB is due to round-trip diffraction loss in the AWG (estimated by simulation), and ˜2.0 dB is due to round-trip propagation and coupling loss in the polymer. The unaccounted for 2.9 dB may be due to AWG phase errors and can be eliminated with improved fabrication or post-fabrication phase-error adjustment.

As mentioned earlier, a possible figure-of-merit for TODCs is dispersion range times bandwidth-squared (bandwidth given by the smaller of the transmissivity 3-dB bandwidth [3 dB being chosen somewhat arbitrarily] or group delay bandwidth), which captures the tradeoff between achievable dispersion and bandwidth. This can be made non-dimensional by giving the dispersion in time/frequency and the bandwidth in frequency. It is a rough measure of the number of adjacent bits that are mixed together by the dispersion if the signal bandwidth occupied the entire TODC bandwidth. Note that this figure-of-merit is different than the one used for DCF, which is the dispersion divided by the loss.

The figure-of-merit for the TODC presented here is ˜16 (1312-ps/nm range with >39-GHz bandwidth). As can be appreciated by those skilled in the art, this number is quite large for a PLC TODC. For comparison, a 4-stage MZI-based PLC TODC might have a figure of merit of only 5.4.

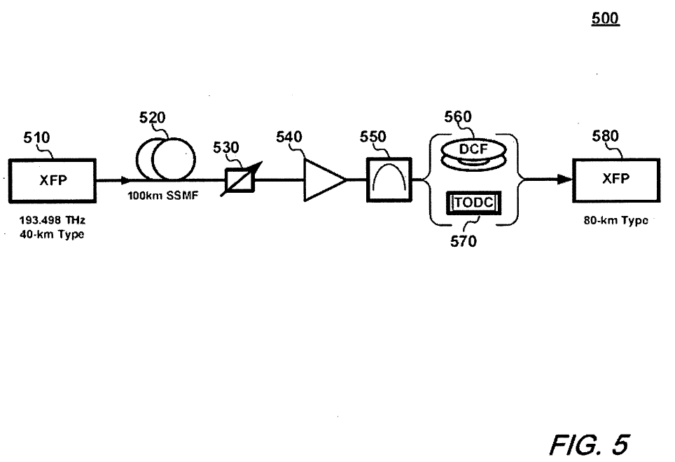

FIG. 5 shows a 10-Gb/s system experimental setup for comparing a TODC as described herein, with DCF. With reference to that FIG. 5, a 9.953-Gb/s non-return-to-zero signal emitted from a 10-Gb/s pluggable transceiver (XFP) 510 with chirp rated for 800 ps/nm is propagated through 100 km of SSMF 520. The carrier frequency is 193.498 THz (i.e., 2 GHz off the ITU grid), and the accumulated dispersion is ˜1700 ps/nm.

The signal is then amplified 540, filtered 550, and passed through either −844 ps/nm of DCF 560 or through the TODC 570, with its dispersion set to −844 ps/nm. The receiver is another XFP 580 with an avalanche photodiode.

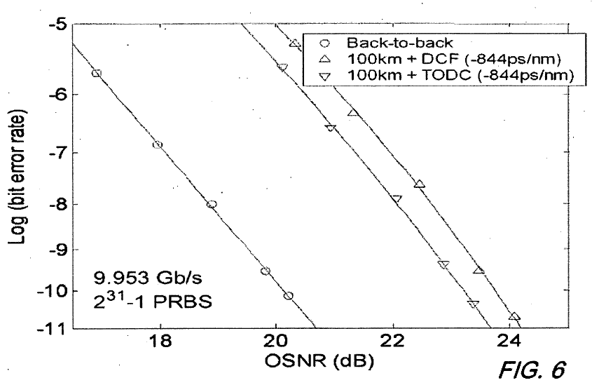

Without any dispersion compensation the observed performance is very poor [10⁻⁵ bit-error rate (BER) at 27-dB optical signal-to-noise ratio (OSNR)]. FIG. 6 shows a graph of BER vs. OSNR for the two cases with dispersion compensation, plus the back-to-back case.

The performance with the TODC is actually slightly better than with the DCF. There is a polarization dependence of ˜0.5 dB in OSNR in the TODC case. DWDM XFPs typically have a ±2.5 GHz end-of-life wavelength accuracy, and one can see from FIG. 3a that the bandwidth should be wide enough to accommodate this drift.

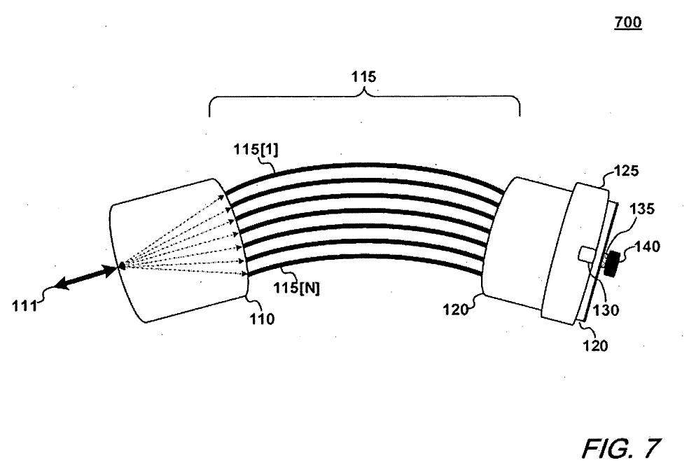

While an exemplary embodiment of a tunable dispersion compensation apparatus has been shown, a number of arrangements of similar apparatus exhibiting inventive teachings are possible. FIG. 7 is a schematic of an alternative embodiment of a tunable dispersion compensator wherein the PLC 125 including heating elements 130 is disposed in an optical path “within the body” of the second slab waveguide 120.

With reference now to that FIG. 7, the dispersion compensation apparatus 700, while similar to that shown earlier in FIG. 2, does not have the PLC 125 positioned adjacent to the second slab waveguide 120. Instead, it is positioned in an optical path within the body of the second slab waveguide 120 itself.

Advantageously, such a configuration may favorably facilitate the fabrication of the dispersion compensation apparatus as receiving grooves (or other shapes—not specifically shown) are scribed or otherwise formed in the body of the slab waveguide 120 where it/they may receive the suitable materials for affecting the thermo-optic lens. As a result, a substantially more integrated device is realized, exhibiting improved manufacturability.

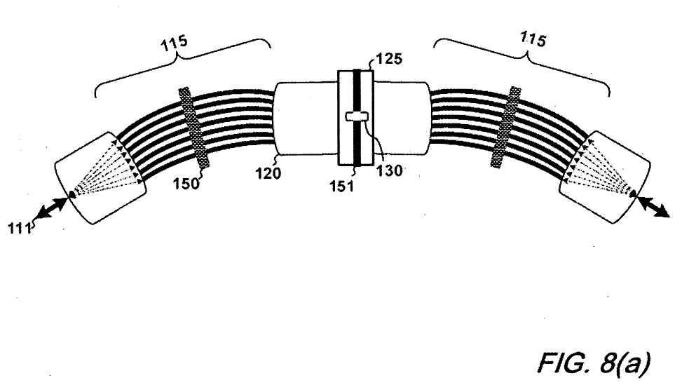

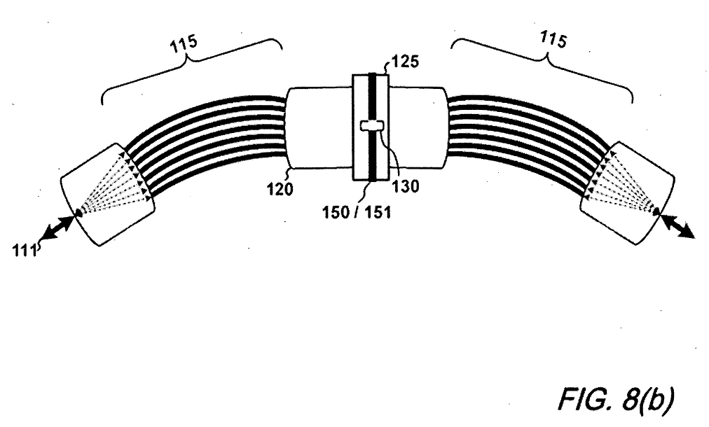

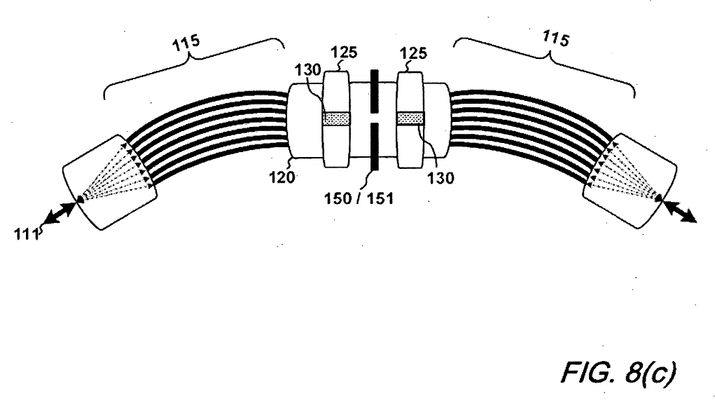

Additional, alternative embodiments are shown in FIGS. 8(a)-(c), wherein “unfolded” dispersion compensation apparatus' are depicted. The unfolded variation generally comprises two frequency routing devices positioned in sequence such that one of the slab waveguides comprising each of the devices are optically coupled, “back-to-back”. An unfolded construction avoids the need for a circulator, or equivalent component, to separate the optical energy output from apparatus from the output energy input to the apparatus in the same fiber. According to an aspect of the invention, a thermo-optic lens is positioned at the interface between the two frequency routing devices.

As shown in FIG. 8(a), a slab waveguide 120 of a frequency routing device is coupled to another frequency routing device. Interposed between and optically coupling the two frequency routing devices, is PLC 125 including heating elements 130 thereby serving as a thermo-optic lens as before. Shown in this FIG. 8(a) is an iris 151 which prevents unwanted optical coupling between the two frequency routing devices. As can be observed from this FIG. 8(a), this apparatus includes a half-wave plate(s) 150, interposed in the grating arms.

A further variation of this dispersion compensation apparatus is shown schematically in FIG. 8(b). More particularly, the half wave plate or a quarter-wave plate is combined with iris assembly 150/151 and the two elements are collectively interposed between the two frequency routing devices. The quarter wave plate must be a set of two quarterwave plates (or one half-wave plate) in the unfolded configuration.

Finally with respect to the unfolded dispersion compensation apparatus, FIG. 8(c) shows a device in which the PLCs 125 are not positioned at the interface between the two frequency routing devices, rather they are positioned in an optical path within their respective slab waveguide(s) 120. As before, the PLC 125 includes heating elements 130 thereby producing a thermo-optic lens while improving the manufacturability of the unfolded device. Also shown in this FIG. 8(c) is integrated iris/half wave plate or quarter-wave plate 150/151 interposed between the two frequency routing devices.

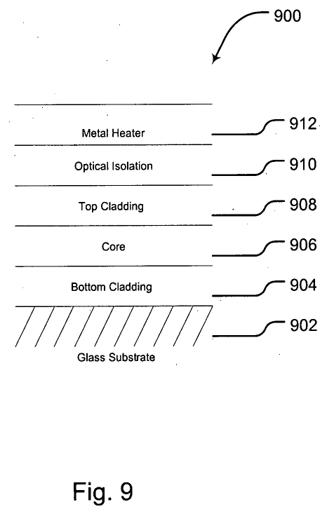

The parabolic (or substantially parabolic) index profile is created dynamically through the delivery of appropriate power levels to the individual heating elements. The concept of using a plurality of controllable heaters to create desired parabolic index profiles can be extended to the dynamic creation of arbitrary index profiles. When used in combination with (or as part of) a passive waveguide chip, many possible optical transforms can be implemented. Given a particular physical arrangement of heaters, such as the 16 parallel heaters used above, the following method can be used to determine the appropriate amount of power to dissipate in each heater in order to generate the desired index profile. In this example, a planar waveguide having the layer structure 900 of FIG. 9 is assumed, having, from top to bottom, a metal heater 912 in the top layer, an optical isolation layer 910 having an index of refraction less than that of the top cladding layer, the top cladding layer 908, the core layer 906, the bottom cladding layer 904, all supported on a substrate 902 which may be glass. Materials, and the methods of formation, are entirely conventional and known in the art. The vertical distance from the metal heater to the core layer may be on the order of 20 u. It is the temperature in the core that is mostly of interest.

First, a desired index of refraction profile is determined for the particular optical transform desired. This profile expresses the desired index of refraction (or index of refraction difference compared to that of unheated core material) at each point transversely under the heater array. Note that this example is for a 2-d cross-section. If a 3-d cross-section is of interest, then this profile should be determined also as a function of length (longitudinal position). The desired index profile is then converted, using known thermo-optic coefficient(s) and other material properties of the core and cladding materials, into a profile of the temperature required at each transverse (and optionally longitudinal) position under the heater array, in order to achieve the desired index profile.

Next, a single heater is considered. Heat from this heater emanates downward toward and through the core, as well as transversely (and longitudinally, in a 3-d analysis), and dissipates in the substrate. A heat conduction model is created depending on the thicknesses and thermal properties of the various layers, and from this the temperature distribution in the core and surrounding layers is calculated as a function of transverse (and optionally longitudinal) position under the heater, and as a function of the power being dissipated in the heater. In some cases the heat conduction model can be represented with an analytical formula (typically with linear or exponential terms), and in other cases a FEM analysis or similar may be used to determine the temperature distribution resulting from applying power to the heater.

Next, assuming all 16 heaters are identical, the temperature distribution as a function of position and heater power is copied 15 times and offset transversely in accordance with the transverse position of the other 15 heaters. Alternatively, if the heaters are not all identical, then the temperature profiles as a function of position and heater power is calculated individually for each heater. It is then assumed to a first approximation that the total temperature increase in the core and surrounding layers at any transverse (and optionally longitudinal) position is equal to the sum of the temperature increases due to all the heaters. In this way it is possible to calculate the temperature distribution at each position under the heater array, as a function of the power being dissipated in each of the 16 heaters. More particularly, the temperature increase at each transverse position x and longitudinal position y is to a first approximation given by

$$T ( x , y ) = {\sum }_{i = 1 …16}^{} {T}_{i} ( x , y ) ,$$

where Ti is the temperature profile generated by heater element i. And the temperature profile Ti can often be written as Tᵢ(x, y)≅pᵢ tᵢ(x, y), where pᵢ is the power applied to the heater element. The function for T(x,y) can sometimes be approximated in such a manner that it can be expressed in closed form, or it can be re-calculated as needed from the finite element analysis.

Finally, a numerical analysis or other iterative or non-iterative method can be used to calculate the power that must be dissipated in each heater in order to achieve the required heating power at each transverse (and optionally longitudinal) position under the heater array.

It is not necessary that the above method produce fully accurate results, since the actual electrical current or voltage applied to each heater can then be adjusted empirically to fine tune the index profile under the heater array. This is a very simple method for creating desired index profiles which are insensitive to process variations such as actual heater dimensions.

Once the electrical current or voltage requirements for all the heaters are determined in this way (or any other way) for the particular index profile, they can be stored digitally in a memory and applied to the individual heaters through respective digital-to-analog converters whenever the particular index profile is desired. Either current or voltage drive can be used in different embodiment. A separate “voltage profile” (or current profile) can be stored in the memory for each different index profile that might be desired, and/or a processor may interpolate between them in order to generate in-between index profiles. Many other variations will be apparent. There may be a small time delay between the selection of a voltage profile and the full realization of the corresponding index profile within the core layer, but such index profiles are typically maintained for long periods of time and typically do not require immediate switching.

As mentioned previously, different magnitudes of the parabolic shape of the index profile under the heaters can achieve different levels of dispersion compensation. Using the digital memory mentioned above, the required voltage profiles for a plurality of different ones of these parabolic shape magnitudes can be stored and applied dynamically to the heaters as desired. Intermediate magnitudes can be interpolated dynamically as well. Alternatively or additionally, a processor can generate the voltage profiles formulaically. But parabolic profiles are not the only index profiles that can be generated using the heater array, and chromatic dispersion compensation is not the only kind of transform that can be achieved. Linear index profiles can be used for beam steering or diffraction, for example, or constant index profiles can be used to introduce a constant phase offset.

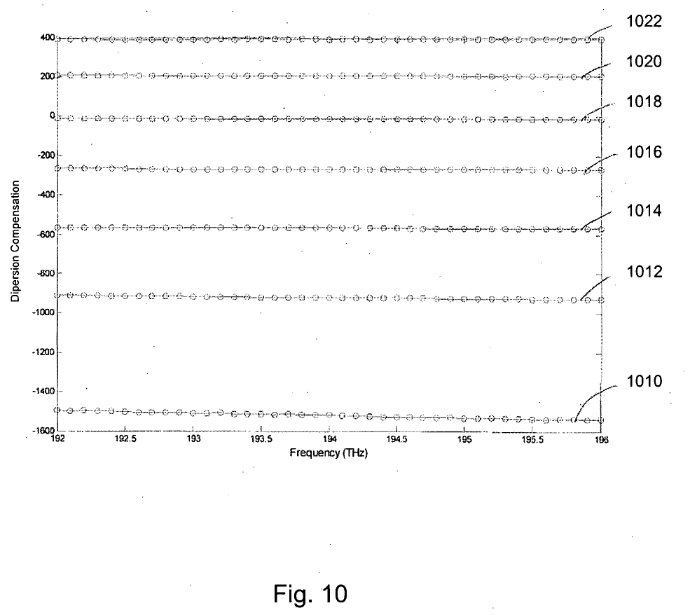

Combination effects are also possible. FIG. 10, for example, illustrates chromatic dispersion compensation achievable with a number of different parabolic index profiles each superimposed on a linear index profile. In FIG. 10, line 1012 illustrates the compensation introduced using the embodiment of FIGS. 3a and 3b, with the heaters turned off. It can be seen that not only is a dispersion compensation of roughly −924 ps/nm introduced (at f=194 THz), but the amount of the compensation undesirably varies slightly as a function of frequency. For 192 THz signals, dispersion compensation is slightly smaller in magnitude, and for 196 THz signals, dispersion compensation is approximately higher in magnitude.

The line 1010 in FIG. 10 illustrates the dispersion compensation when the heater array 340 is activated using a first voltage profile. This voltage profile is such that the resulting index profile is negative and approximately parabolic, with a first magnitude, but the effect is summed with the intrinsic effect. The resulting compensation varies from about −1500 to about −1550 ps/nm across the frequency spectrum.

Similarly, the lines 1014, 1016, 1018, 1020 and 1022 each illustrate the dispersion compensation when the heater array 340 is activated using respective different voltage profiles. These voltage profiles are designed to induce positive parabolic index profiles and therefore add respective different amounts of positive dispersion to the intrinsic effect of line 1012.

In FIGS. 1, 2, 3, 8(a) and 8(b), the thermo-optic lens is disposed at the focal plane of the optical energy. This is advantageous because each of the frequency channels is represented in this plane by a respective discrete lobe in the interference pattern. The lobes are spatially separated transversely under the heater array, thereby permitting high frequency selectivity in the optical transform introduced by the index profile. Frequency selectivity is maximum in an embodiment like that of FIG. 8(a), an unfolded embodiment in which the longitudinal center of the lens is disposed directly over the focal plane. In other embodiments, the lens can be placed at other focal planes along the optical path, for example at the optical input/output port 110 of the AWGs of FIGS. 1 and 2. In one embodiment, the thermo-optic lens is formed inside a trench etched into the second slab region of the AWG, inside but adjacent to the output edge thereof. By forming the lens in a trench, fabrication is simplified because it is no longer necessary to abut the polymer PLC up against the output edge of the silicon PLC accurately. Also, it is not necessary that the polymer PLC be much wider (transversely) than the Brillouin zone width, as shown in FIGS. 1, 2, 3, 7 and 8(a)-8(c). Note that while the focal plane is referred to herein as a “plane”, it will be appreciated that this plane is actually curved.

But not all potentially desirable transforms require the frequency selectivity achievable at a focal plane. For example, frequency selectivity might not be necessary if all that is desired is to steer the entire beam, or to introduce some offset that is constant across the frequency spectrum. Where frequency selectivity is less important, the thermo-optic lens can be disposed anywhere along the optical path. As examples, it can be disposed across either of the AWG slab members as shown in FIGS. 7 and 8(c), or it can cut across the grating of the AWG.

Many other variations are possible for the arrangement of heaters on the thermo-optic lens. For example, other numbers of heaters may be used other than 16. The heaters may also be oriented at angles relative to each other rather than parallel to each other, and some heaters may have different shapes and/or lengths along the optical path than others of the heaters. Another option is to place one or more of the heaters on the substrate (between polymer and glass in this example) or within the polymer stack. In another embodiment either the core or cladding material is somewhat electrically conductive, and electrodes are connected to it in a desired pattern to cause current flow therein, so that the core or cladding material doubles as the heater material. Many other variations will be apparent to the reader, and offer extensive flexibility in the design of a dynamically alterable index profile for achieving dynamically alterable optical transforms. The induced index profiles may be designed to be parabolic or any other shape, and may introduce any desired group delay vs. frequency curve. A full 3-d description of the thermal profile may be needed for some embodiments, but the overall principle does not change. It is still possible to find a heater arrangement and combination of heater powers that closely matches the required 3-d temperature profile and thus generates the desired refractive index profile.

A parabolic index profile is ideal for compensating group delay that is linear with frequency. This is most desirable for compensating for dispersion introduced by lengths of optical fiber, which tends to introduce this kind of group delay. But the transmission path might include components other than optical fiber, and those components might introduce group delay components that are non-linear. A lens profile that deviates from the purely parabolic is desirable for compensating for the dispersion introduced by those components as well. The arbitrary tunability of embodiments of the present invention permits a user to characterize the actual group delay in a particular path, adjust the desired index profile to compensate for the actual group delay, and calculate the power required for each heater to develop that desired index profile.

Note that the layer geometry also can be optimized to create a suitable refractive index profile. In particular, the thicknesses of core and cladding can be varied and the substrate material can be varied. When individual heaters are used, because of their discrete nature, the thermal profile may have ripples. An optimized combination of layer thicknesses, heater geometry, and thermal properties of the materials can result in a thermal distribution with an insignificant amount of ripple.

Also, the use of heaters to generate an arbitrary index profile requires materials with a proper combination of refractive indices, thermo-optic coefficients, and thermal properties (including thermal conductivity and heat capacity). For example, if a 50 u heater pitch is desired, and the heating elements are 20 u above the core layer, then the materials should be such that sufficient heat from each heater will reach into the core and cladding regions to effect the desired refractive index changes without requiring a huge power dissipation in the heaters. Also, it is desirable that the core and cladding have closely matched thermo-optic coefficients so that the heater power does not noticeably compromise the vertical confinement of the light. In most cases, the required properties are found or can be designed much more often in polymer materials than in silica materials. However, in some embodiments of the invention the thermo-optically induced lens is formed in a non-polymer material, such as a silica or LiNb. In addition, the materials and the layer thicknesses in the stack should be such as to minimize the ripples in the temperature profile in the core and cladding layers, due to the discrete nature of the heater array.

Still further, the concept of arbitrarily-induced index profiles can also be extended to electro-optic embodiments. In an electro-optic embodiment, the electrodes can be formed above and below the vertical confinement layers of the device in order to form electric fields passing vertically through the core layer. By individually controlling the voltage across each of the electrode pairs, wide flexibility is available for electro-optically inducing a desired index profile in the core layer of the device, to thereby introduce the desired optical effect. As used herein, the term “applicator” refers to the electrically conductive feature(s) on the device to which an electrical signal is applied in order to induce the desired index variation within the device. For thermo-optic devices, the applicators comprise heating elements through which electrical current is passed; and for electro-optical devices, the applicators comprise the top and bottom electrodes across which an electrical potential is formed.

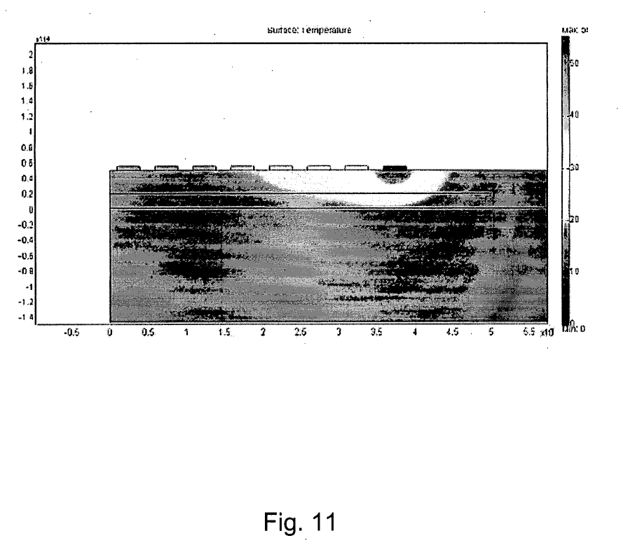

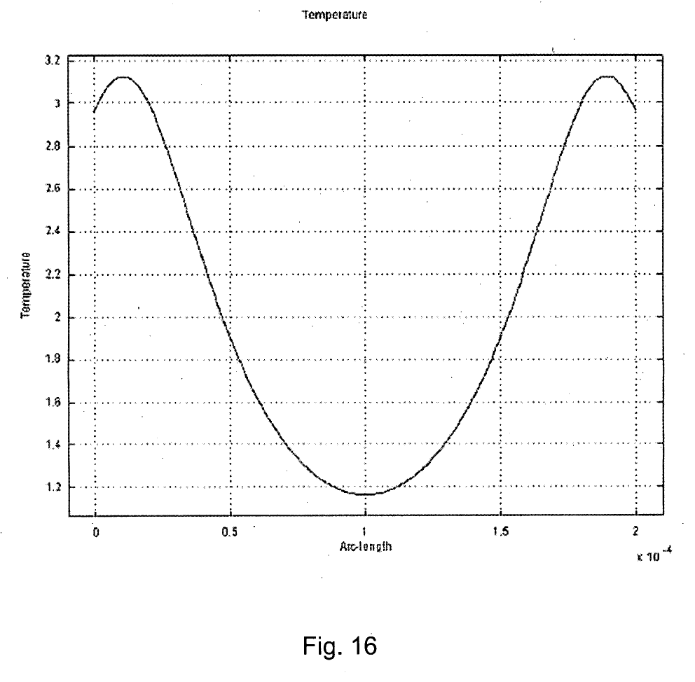

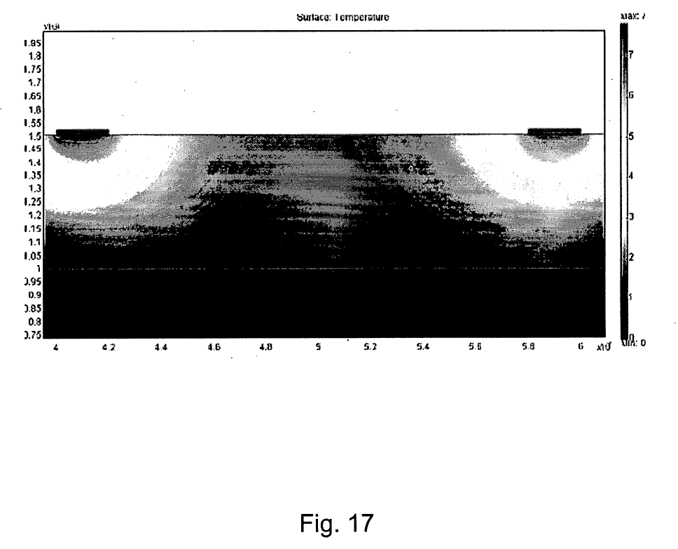

Some additional details are shown in FIGS. 11-18. In particular:

FIG. 11 shows a 2-d cross-sectional plot. In this drawing, all heaters are 30 um wide with a 20 um gap in between. Line indicates position of core layer.

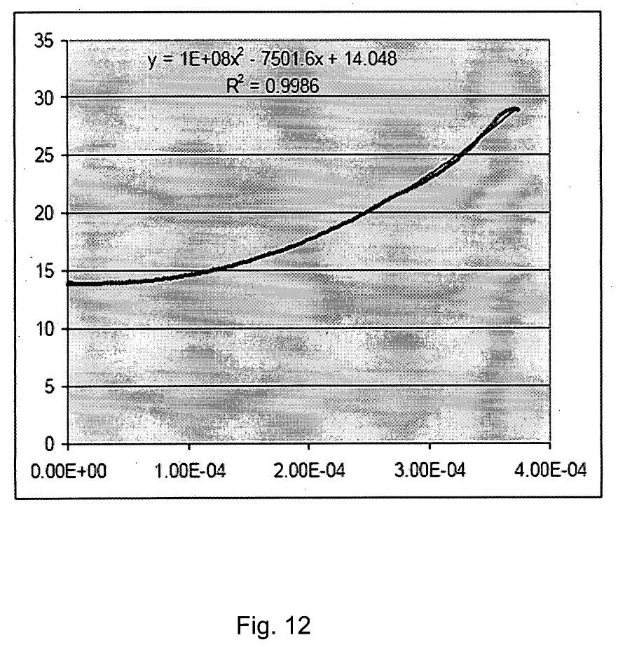

FIG. 12 shows that heat increases in core layer as a function of transverse distance for an optimized set of heater powers. Only half of the parabola is shown.

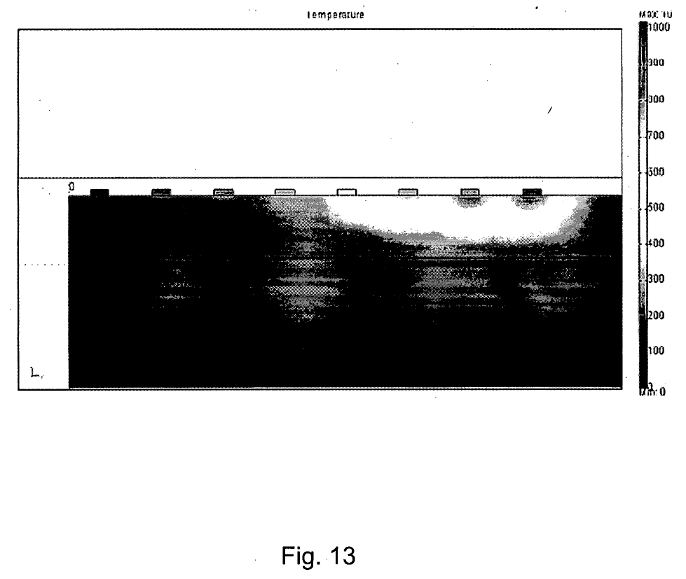

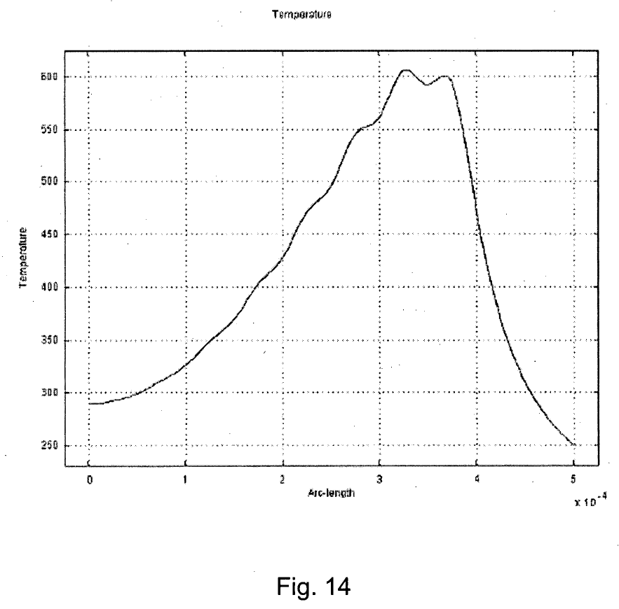

FIGS. 13 and 14: Discrete nature of electrodes can result in ripples in temperature if geometry and materials (thermal properties) are not properly chosen. FIG. 13 shows a cross-section of the relevant polymer chip layers in color (red=hot, blue=cold). FIG. 14 shows a plot of the same thing.

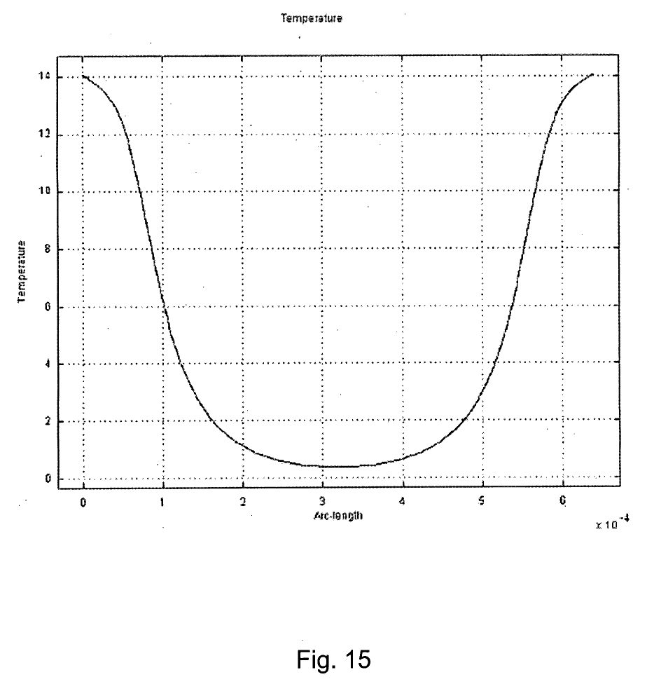

FIGS. 15-17 show what happens if a heater array of only two heating elements is used. Temperature behavior is smooth, but it is difficult to obtain arbitrary or custom profiles.

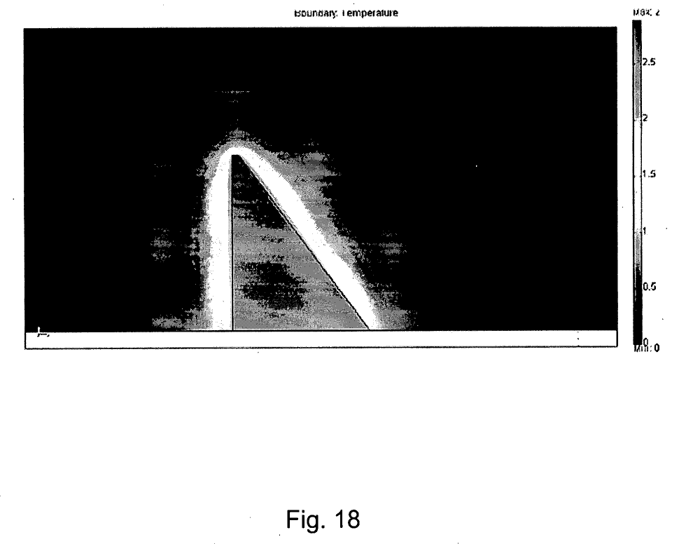

FIG. 18 shows the temperature profile formed due to a triangular electrode. A top view is shown, with colors representing the temperature

At this point, while the invention has been discussed and described using some specific examples, those skilled in the art will recognize that the teachings herein are not so limited. In particular, different materials—both polymeric and other may be used as thermo-optic PLC devices, where their optical and thermal characteristics are suitable. In addition, while a waveguide grating is shown in the examples, other PLC-based gratings such as an echelon diffraction grating could be used as well. Accordingly, the invention should be only limited by the scope of the claims.

1. A device for performing a selected optical transform on an optical signal, comprising:
an AWG de-multiplexer having a waveguide array and an output slab waveguide, the output slab waveguide including a lens region, the output slab waveguide in at least the lens region including a material whose index of refraction is variable in dependence upon applied energy; and
an array of separately-addressable energy applicators, disposed and oriented to induce a desired index profile in the lens region.

2. A device according to claim 1, wherein the index of refraction of the material is variable in dependence upon applied heat energy, and wherein each of the energy applicators comprises a respective heater.

3. A device according to claim 1, wherein the index of refraction of the material is variable in dependence upon an applied electric field, and wherein each of the energy applicators comprises a respective electrode pair.

4. A device according to claim 1, wherein the array is linear.

5. A tunable optical transform method, comprising the steps of:
receiving an input optical signal in a planar waveguide, at least a lens portion of the planar waveguide including a material whose index of refraction is variable in dependence upon applied energy; and
individually controlling the energy applied to each of a plurality of energy applicators distributed transversely across the optical signal to thereby induce a desired index of refraction profile transversely across the optical signal.

6. A method according to claim 5, wherein the index of refraction of the material is variable in dependence upon applied heat energy, wherein each of the energy applicators comprises a respective heater, and wherein the step of individually controlling the energy comprises the step of delivering individually controlled power levels to each of the heaters

7. A method according to claim 5, wherein the index of refraction of the material is variable in dependence upon an applied electric field, wherein each of the energy applicators comprises a respective electrode pair, and wherein the step of individually controlling the energy comprises the step of providing individually controlled voltage levels across each of the electrode pairs.

8. A method according to claim 5, wherein the desired index of refraction profile is parabolic in magnitude.

9. A method according to claim 5, wherein the desired index of refraction profile deviates in magnitude from the parabolic

10. A method according to claim 5, further comprising the step of storing in a memory, an indication of the amount of energy to be applied to each of the plurality of energy applicators to induce the desired index profile, wherein the step of individually controlling comprises the step of individually controlling the energy applied to each of the plurality of energy applicators in dependence upon the indications stored in the memory.

11. A method according to claim 10, further comprising the steps of storing in the memory, second indications of the amount of energy to be applied to each of the plurality of energy applicators to induce a second desired index profile; and individually controlling the energy applied to each of the plurality of energy applicators in dependence upon the second indications to thereby induce a second desired index of refraction profile transversely across the optical signal, different from the first index of refraction profile.

12. A method according to claim 5, wherein the transverse distribution of energy applicators is linear.

13. A method for transforming an optical signal, comprising the steps of:
providing a planar optical waveguide including a material whose index of refraction is variable in dependence upon applied energy;
providing a plurality of individually-controllable energy applicators distributed transversely across an optical path in the planar waveguide;
determining a desired transverse index of refraction profile to be induced in the optical path in the planar waveguide;
determining the energy to be applied to each of the energy applicators individually in order to induce the desired transverse index of refraction profile; and
storing, in a memory associated with the energy applicators, an indication of the amount of energy determined in the step of determining the energy to be applied.

14. A method according to claim 13, further comprising the step of applying to each of the energy applicators individually the energy determined in the step of determining the energy to be applied.

14. A method according to claim 13, further comprising the step of determining a desired optical transform to be performed on an optical signal in the optical path, wherein the step of determining a desired transverse index of refraction profile comprises the step of determining the desired transverse index of refraction profile in dependence upon the desired optical transform.

15. A method according to claim 13, wherein the index of refraction of the material is variable in dependence upon applied heat energy, wherein each of the energy applicators comprises a respective heater, and wherein the step of applying energy to each of the energy applicators comprises the step of delivering a respective electrical power level to each of the heaters individually.

16. A method according to claim 13, wherein the index of refraction of the material is variable in dependence upon applied electric field, wherein each of the energy applicators comprises a respective pair of electrodes, and wherein the step of applying energy to each of the energy applicators comprises the step of providing a respective voltage level across each of the electrode pairs individually.

17. A method according to claim 13, wherein the transverse distribution of energy applicators is linear.
